(19) United States
(12) Patent Application Publication
(10) Pub. No.: US 2026/0244908 A1
(43) Pub. Date: Aug. 20, 2026

(54) NEURAL NETWORK WEIGHT COMPRESSION

(71) Applicant: GUANGDONG OPPO MOBILE TELECOMMUNICATIONS CORP., LTD., Dongguan (CN)

(72) Inventors: Maciej WAWRZYNIAK, Poznan (PL); Marek DOMANSKI, Poznan (PL); Tomasz GRAJEK, Poznan (PL); Slawomir MACKOWIAK, Poznan (PL); Slawomir ROZEK, Poznan (PL); Olgierd STANKIEWICZ, Poznan (PL); Jakub STANKOWSKI, Poznan (PL)

(73) Assignee: GUANGDONG OPPO MOBILE TELECOMMUNICATIONS CORP., LTD., Dongguan (CN)

(21) Appl. No.: 19/641,753

(22) Filed: Apr. 8, 2026

Related U.S. Application Data
(63) Continuation of application No. PCT/CN2024/123490, filed on Oct. 8, 2024.

(30) Foreign Application Priority Data
Oct. 9, 2023 (EP) 23461659.7

(51) Int. Cl. G06N 3/0495; G06T 5/60

(52) U.S. Cl. CPC G06N 3/0495; G06T 5/60

(57) ABSTRACT

According to a first aspect, there is provided a method of compressing a set of weights for a neural network, the method comprising: receiving, from a source, a plurality of weights of a neural network in a first number format, wherein a weight is represented in the first number format by N bits comprising a plurality of bits representing an exponent of the weight, a plurality of bits representing a mantissa of the weight and one bit representing a sign of the weight; and converting the plurality of weights into a second number format, wherein a weight is represented in the second number format by b_{w} bits comprising a plurality of bits representing the exponent of the weight, a plurality of bits representing the mantissa of the weight and one bit representing a sign of the weight, wherein b_{w}<N.

### CROSS-REFERENCE TO RELATED APPLICATIONS

This application is a continuation of International Application No. PCT/CN2024/123490, filed on Oct. 8, 2024, which claims priority to EP patent application Ser. No. 23/461,659.7, filed on Oct. 9, 2023. The disclosures of the aforementioned applications are hereby incorporated by reference in their entireties.

### TECHNICAL FIELD

The present application relates to the field of neural network compression, in particular to methods, systems and apparatus for compressing and decompressing weights of a neural network.

### BACKGROUND

Artificial neural networks are increasingly used for various purposes. For example, in the context of image processing, neural networks are used for numerous applications, such as: image classification, image segmentation, object detection, image generation, image restoration, image captioning or the like. During training, tuning, optimization, evaluation, and testing of the network, multiple sets of network weights are utilized, which are stored in files that, even after compression, have a large file size. The file size is influenced by the number of weights used in the network and the precision with which the weights are stored. In some applications of neural networks, for example in image processing, the number of significant digits is excessive.

Weights in artificial neural networks used in image processing are typically stored in floating-point format. The most commonly used format is 32-bit single precision floating-point format. In some solutions, double precision floating-point format is used to store weights. The IEEE 754-2008 standard is one of the most important standards for representing and performing arithmetic on floating-point numbers. This standard describes two basic ways of representing floating-point numbers, as known from the IEEE 754 standard: single precision format, in which a floating-point number is stored on 32 bits (1 bit for a sign, 8 bits for an exponent, 23 bits for a mantissa), and double precision format, in which a floating-point number is stored on 64 bits (1 bit for a sign, 11 bits for an exponent, 52 bits for a mantissa). This standard also introduces additional formats for floating-point numbers, such as extended precision, where 80, 96, 128, or more bits can be used.

### SUMMARY

Embodiments of the present application provide a method, a decoder/decompressor, an encoder/compressor, and a computer-readable medium for compressing/decompressing neural network weights.

According to a first aspect, there is provided a method of compressing a set of weights for a neural network, the method performed by a video encoder or audio encoder, the method comprising: receiving a plurality of weights of a neural network in a first number format, wherein in a weight is represented in the first number format by N bits comprising a plurality of bits representing an exponent of the weight, a plurality of bits representing a mantissa of the weight and one bit representing a weight sign; and converting the plurality of weights into a second number format, wherein a weight is represented in the second number format by b_{w} bits comprising a plurality of bits representing the exponent of the weight, a plurality of bits representing the mantissa of the weight and one bit representing a weight sign, wherein b_{w}<N. Converting the weights to the second number format comprises: determining a minimum number of significant bits for representing the mantissas of the weights of the neural network and/or a minimum number of significant bits for representing the exponents of the weights of the neural network that maintains a threshold performance of the neural network; and approximating the mantissa and/or exponent of a weight of the weights as a plurality of bits of length equal to the minimum number of significant bits for representing the mantissas and/or exponent respectively. The method further includes: encoding the plurality of weight of the second number format into a bitstream.

In some embodiments, determining the minimum number of significant bits for representing the mantissas of the weights of the neural network that maintains the threshold performance of the neural network comprises: determining a minimum number of significant digits for representing the mantissas of the weights of the neural network; and converting the minimum number of significant digits to the minimum number of significant bits.

In some embodiments, determining a minimum number of significant digits for representing the mantissas of the weights of the neural network comprises: iteratively increasing a number of significant bits for representing the mantissas of the weights from an initial value until the threshold performance of the neural network is reached.

In some embodiments, iteratively increasing a number of significant digits for representing the mantissas of the weights from an initial value until the threshold performance of the neural network is reached comprises, at each iteration: determining a candidate number of significant digits of the mantissa for the iteration; generating a candidate set of weights for the iteration by reducing the number of significant digits of the mantissas of the weights to the candidate number of significant digits of the mantissa; executing the neural network with the candidate set of weights on a set of test data; comparing the performance of the neural network with the candidate set of weights to the threshold performance; and if the threshold performance is reached, setting the minimum number of significant digits for representing the mantissas of the weights to the candidate number of significant bits of the mantissa for the iteration.

In some embodiments, comparing the performance of the neural network with the candidate set of weights to the threshold performance comprises: determining values of one or more metrics on output data obtained from executing the neural network with the candidate set of weights on the set of test data; comparing the determined values of the one or more metrics to one or more threshold values.

In some embodiments the neural network is an image generation or image enhancement neural network.

In some embodiments, the one or more metrics comprise one or more of: a mean square error; a peak signal to noise ratio; a structural similarity index measure; and/or a visual information fidelity.

In some embodiments, converting the plurality of weights into the second number format further comprises: determining a minimum number of significant bits for representing the exponents of the weights of the neural network that maintains the threshold performance of the neural network; and approximating the exponents of a weight of the weights as a plurality of bits with length equal to the minimum number of significant bits for representing the exponents.

In some embodiments determining the minimum number of significant bits for representing the exponents of the weights of the neural network that maintains the threshold performance of the neural network comprises: iteratively increasing a number of significant bits for representing the exponents of the weights from an initial value until the threshold performance of the neural network is reached.

In some embodiments, iteratively increasing a number of significant bits for representing the exponents of the weights from an initial value until the threshold performance of the neural network is reached comprises, at each iteration: determining a candidate number of significant bits of the exponents for the iteration; generating a candidate set of weights for the iteration by reducing the number of significant bits of the exponents of the weights to the candidate number of significant bits of the exponents; executing the neural network with the candidate set of weights on a set of test data; comparing the performance of the neural network with the candidate set of weights to the threshold performance; and if the threshold performance is reached, setting the minimum number of significant bits for representing the exponents of the weights to the candidate number of significant bits of the exponents for the iteration.

In some embodiments, comparing the performance of the neural network with the candidate set of weights to the threshold performance comprises: determining values of one or more metrics on output data obtained from executing the neural network with the candidate set of weights on the set of test data; comparing the determined values of the one or more metrics to one or more threshold values.

In some embodiments, the method further comprises: packing the plurality of weights in the second number format into a plurality of N-bit strings to form a compressed representation of the plurality of weights.

In some embodiments, packing the plurality of weights in the second number format into a plurality of N-bit numbers comprises: sequentially ordering the weights in the weights in the second number format such that the ordering of the weights corresponds to an indexing of the weights of the neural network.

In some embodiments, packing the plurality of weights in the second number format into a plurality of N-bit numbers comprises: determining a number of N-bit numbers, p, for storing a batch of k weights, wherein p<k; dividing the plurality of weights in the second format into a plurality of sets of k weights; and packing each set of k weights into a respective set of p N-bit numbers.

In some embodiments, the method further comprises storing the compressed representation of the plurality of weights in a memory.

In some embodiments, the method further comprises: encoding the compressed representation of the plurality of weights into a bitstream; and transmitting the bitstream from a first network node to a second network node.

In some embodiments, the first number format is a single precision floating point number format or a double precision floating point number format.

According to a second aspect, there is provided a computer-readable medium comprising computer executable instructions stored thereon that, when executed by a computer, cause the computer to perform any of the methods of the first aspect.

According to a third aspect, there is provided a system comprising: one or more processors; and a computer-readable medium comprising computer executable instructions stored thereon that, when executed by a computer, cause the computer to perform any of the methods of the first aspect.

According to a fourth aspect, there is provided a method of decoding weights for a neural network, the method performed by a video decoder or audio decoder, the method comprising: parsing a bitstream to obtain one or more sets of p N-bit numbers, and N-bit number indicating a respective k weights of the neural network, wherein the N-bit numbers have a length of a first number format, and the weights are represented in one or more second number formats, wherein 1≤p<k; parsing the bitstream to obtain an indication of a respective mantissa length and/or respective exponent length of the one or more second number formats; extracting the weights of the neural network from the one or more sets of p N-bit numbers based on the respective mantissa length and/or respective exponent length of the second number format.

In some embodiments, the method further comprises: executing a neural network with the extracted weights on one or more sets of input data to generate one or more sets of output data.

In some embodiments, the neural network performs an image processing task, and the one or more sets of input data comprise an input image.

In some embodiments, the image processing task comprises one or more of: an image enhancement task; an image generation task; an image classification task; an image segmentation task; an image captioning task; and/or an object detection task.

In some embodiments, the order of the weights of the neural network in the one or more sets of p N-bit numbers corresponds to a predefined indexing of the neural network weights.

According to a fifth aspect, there is provided a computer-readable medium comprising computer executable instructions stored thereon that, when executed by a computer, cause the computer to perform any of the methods of the fourth aspect.

According to a sixth aspect, there is provided a system comprising: one or more processors; and a computer-readable medium comprising computer executable instructions stored thereon that, when executed by a computer, cause the computer to perform any of the methods of the fourth aspect.

These and other aspects of the present application may become more readily apparent from the following description of the embodiments.

### BRIEF DESCRIPTION OF THE DRAWINGS

Embodiments will now be described, by way of example only, with reference to the accompanying drawings, in which:

FIG. 1A shows a flowchart of operations of an encoder/compressor according to various embodiments;

FIG. 1B shows a flowchart of operations of a decoder/decompressor according to various embodiments;

FIG. 2A shows a flowchart of a method for determining a minimum number of significant digits for representing mantissas of weights of a neural network;

FIG. 2B shows a flowchart of a method for determining a minimum number of significant digits for representing exponents of weights of a neural network;

FIG. 3 shows a flowchart of an example method 300 for packing weights in a second number format into numbers in a first number format;

FIG. 4A shows an example of packing k weights into p floating point numbers;

FIG. 4B shows an example of packing 3 weights into 2 floating point numbers;

FIG. 4C shows an example of packing 2 weights into 1 floating point number;

FIG. 5 shows a schematic illustration of an encoder/compressor according to various embodiments; and

FIG. 6 shows a schematic illustration of a decoder/decompressor according to various embodiments.

### DETAILED DESCRIPTION

Technical solutions in the embodiments of the present application will be described clearly and completely below with reference to the accompanying drawings.

The technical solutions described herein may applied in any coding system that involves compression and/or decompression of neural network weights. Furthermore, while these principles are primarily illustrated with reference to image processing, they are also applicable to other data forms, including video processing, natural language processing and/or audio processing.

An “encoder” is a device capable of encoding data into a bitstream, while a “decoder” is a device capable of decoding the bitstream in order to obtain the encoded data, or an approximation of the encoded data. A “bitstream” comprises a sequence of bits.

A “compressor” is a device capable of compressing data into a compressed representation, i.e., a representation with a smaller size than the original data, while a “decompressor” is a device capable of decompressing the compressed representation in order to obtain the original data, or an approximation of the original data.

A “neural network” is a machine-learning model comprising a plurality of “nodes” arranged in one or more “layers”. Each node takes as input one or more outputs of nodes in a previous layer of the neural network, or one or more initial inputs to the neural network, and generates an output based on a set of “weights” associated with the node. For example, a node may determine a weighted sum of inputs to the node and apply a non-linear function to the sum to generate the node output. The non-linear function (also referred to herein as an “activation function”) may, for example, be a sigmoid function, a tanh function, a ReLU function or the like. As used herein, the term “weight” may encompass weights and/or biases of a neural network.

Layers of a neural network may comprise one or more of: one or more fully connected layers; one or more convolutional layers; one or more recurrent layers; one or more long short-term memory (LSTM) layers; one or more attention layers; or the like. A neural network may comprise one or more skip connections between layers. A neural network may, for example, have a transformer architecture, a convolutional architecture, a residual network architecture, a recurrent architecture, an autoencoder architecture or the like.

Neural networks can be used of image processing tasks. Examples of such tasks include, but are not limited to, image generation; image enhancement (e.g., denoising, super-resolution, etc.); image classification; image segmentation; object detection; and/or image captioning. Neural networks can alternatively or additionally be used for audio processing tasks. Examples of such tasks include, but are not limited to, audio generation; audio enhancement (e.g., denoising); audio classification; hotword detection; and/or speech-to-text transcription.

A “number format” is a bit string format used to represent numbers. Floating point number formats are number formats that comprise a “mantissa” (also referred to as a “significand”, a “coefficient” and/or an “argument”) representing a predefined number of significant digits of a number and an “exponent” (which may in general be signed), and, in some examples, further comprise a sign bit indicating whether the number is positive or negative.

This specification describes an approach to reduce bits separately for the mantissa and/or exponent of weights of a neural network. The bit reduction method for the mantissa utilizes the fact that weights act as coefficients by which propagating signals are multiplied in the neural network. The number of significant digits in the decimal system is reduced to the minimum required to maintain a desired functionality/threshold performance of the network. Next, the number of bits required to represent the weights after reducing the number of significant digits of the mantissa is computed. In some embodiments, the minimum number of bits for representing the exponent of the weights while maintaining the threshold performance/functionality is also determined.

The performance of a neural network may be evaluated using one or more metrics. For a given metric value, both the mantissa and the exponent contain redundant information. Thus, the number of significant digits for the mantissas nₘ and number of bits for the exponents nₑ of each weight can be reduced with minimal effect on the performance of the neural network, e.g., while maintaining a performance of the neural network above a threshold value. The minimum values of nₘ and nₑ can be determined for a chosen metric or multiple selected metrics, using the data used for network testing.

In some embodiments, the systems, methods and apparatus disclosed herein may be applied to artificial neural networks used for image processing, such as image generation and/or restoration. Subjective image quality assessment involves the use of one or more image quality metrics, such as mean square error (MSE), peak signal to noise ratio (PSNR), structured similarity index (SSIM), and/or visual information fidelity (VIF). In some embodiments, the systems, methods and apparatus disclosed herein may be applied to artificial neural networks used for audio processing, such as audio generation and/or restoration.

In some embodiments, solutions may further involve using the bits of a floating-point number to store more than one weight of a neural network. To achieve this, after determining the minimum number of significant digits/bits for representing the mantissas/exponents, i.e., the values of nₘ and nₑ, a number, p, of floating-point numbers that will be used to store k network weights is determined. The ratio of k/p determines the reduction of data space for weights. This can allow for an initial reduction in the amount of float-type data used to store neural network weights.

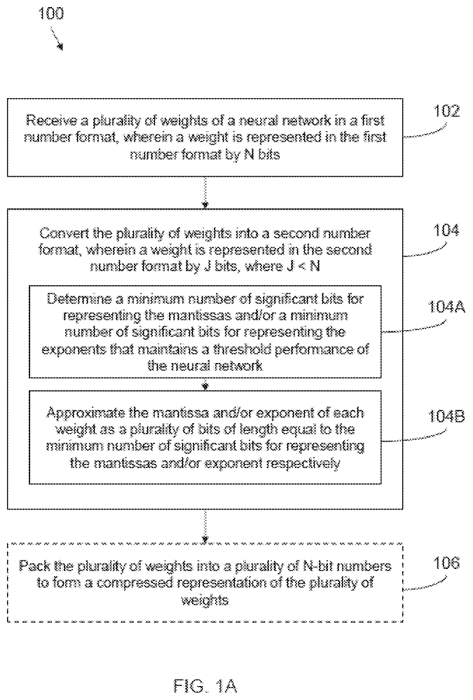

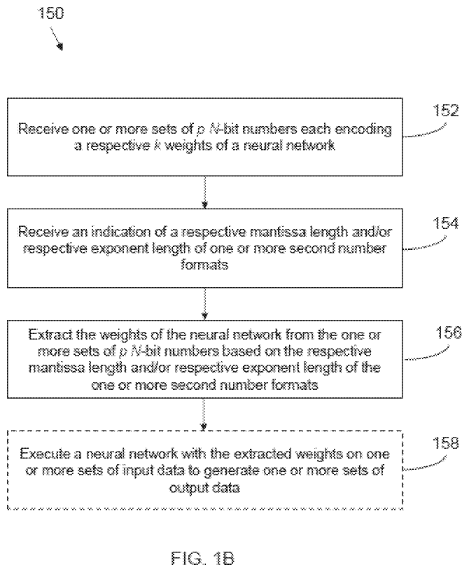

FIG. 1A shows a flowchart of the operations 100 of an encoder/compressor according to some embodiments. The encoder may be a video encoder and/or an audio encoder. FIG. 1B shows a flowchart of the operations 150 of a decoder/decompressor according to the first embodiment. The decoder may be a video decoder and/or an audio decoder.

At operation 102 of FIG. 1A, a plurality of weights of a neural network are received, e.g., from a source, such as a memory of the encoder or a memory accessible by the encoder. The neural network may be a neural network used by a video codec and/or an audio codec. The weights are received in a first number format that represents each weight by an N-bit string. Each N-bit string comprises a plurality of bits representing an exponent of a weight, a plurality of bits representing a mantissa of the weight, and a sign bit indicating a sign of the weight (i.e., positive or negative). The first number format may be a floating-point number format, e.g., a single precision or double precision floating point number.

At operation 104, the plurality of weights are converted into a second number format. Each weight is represented in the second number format by a J=b_{w}-length bit string, where b_{w} is less than N (i.e., the length of numbers in the first number format). Each b_{w}-length bit string comprises a plurality of bits representing an exponent of a weight and a plurality of bits representing a mantissa of the weight. The second number format may be a floating-point number format.

Converting the plurality of weights into the second number format comprises determining 104A a minimum number of significant bits for representing the mantissas, bₘ, and/or a minimum number of significant bits for representing the exponents, nₑ, of the weights that maintains a threshold performance of the neural network on a test dataset.

In some embodiments, determining the number of significant bits for the mantissa comprises determining a minimum number of significant digits, nₘ, for representing the mantissa, and converting this into a minimum number of significant bits, bₘ, for representing the mantissa.

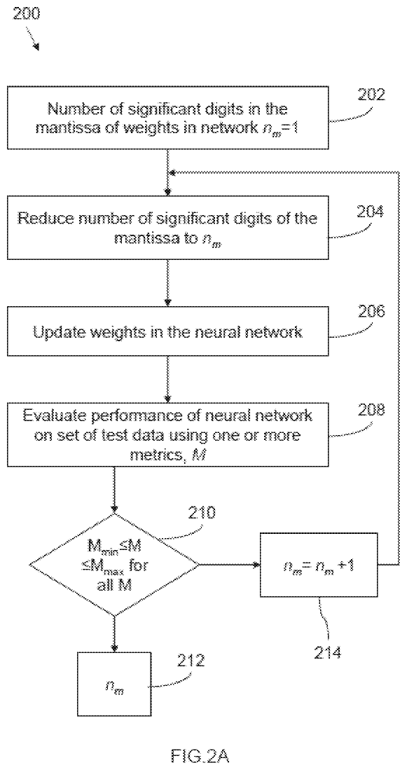

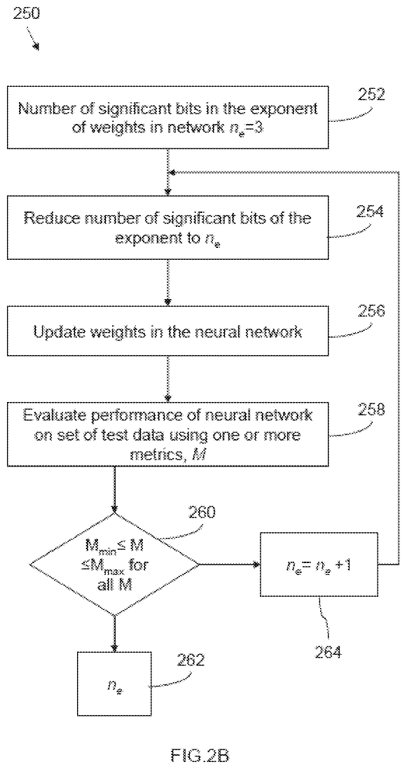

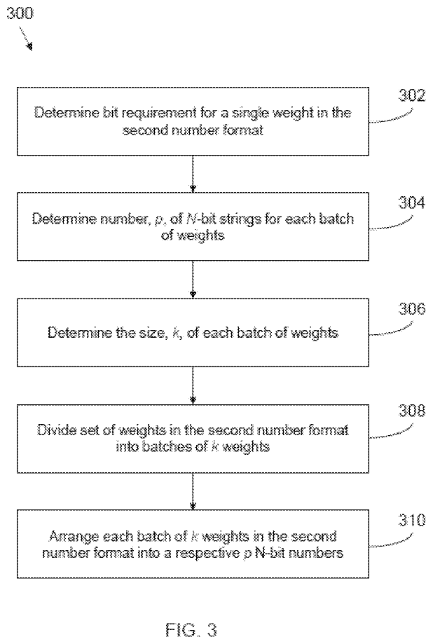

Examples of methods of determining the minimum number of significant digits/bits for representing the mantissas and/or exponents of the weights are described in further detail herein with respect to FIGS. 2A and 2B.

Once the minimum number of significant bits for representing the mantissas and/or exponents of the weights has been determined, the mantissas of the weights are approximated 104B as a bitstring of length bₘ and/or the exponents are approximated as a bitstring of length nₑ. The corresponding representation of a weight in the second number format thus has a length, b_{w}, of at least bₘ+nₑ bits, plus one bit for the weight sign, e.g., bₘ+nₑ+1 bits. In some embodiments, the sign bit may be omitted. Since the length of a representation of a number, b_{w}, in the second number format is less than the length of a representation of a number, N, in the first number format, this results in a compression of the weights of the neural network.

In some embodiments, the neural network have differing precision requirements for different modules of the neural network, e.g., each module of the neural network is associated with a respective threshold performance. When compressing the neural network weights for a module of the neural network, the respective threshold performance of the module is used in operations 104A and 104B. Consequently, in general, each module of the neural network can have its weights encoded into a respective second number format. In general, the second number format may not be identical for all of the modules of the neural network.

After operation 104B, the plurality of weights of the second number format are encoded into a bitstream.

In some embodiments, at operation 106, the plurality of weights in the second number format determined at operation 104B are packed into a plurality of N-bit strings, i.e., into a plurality of strings that each have the same length as a number represented in the first number format. In some embodiments, the weights in the weights in the second number format are sequentially ordered in the N-bit strings such that the ordering of the weights corresponds to an indexing of the weights of the neural network.

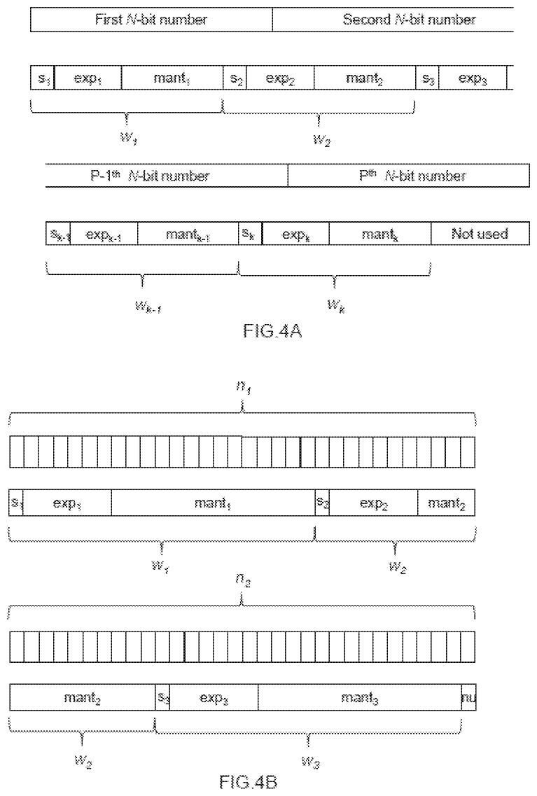

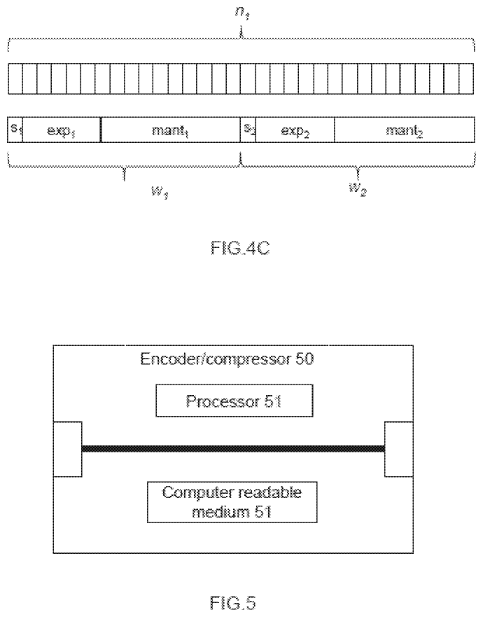

The set of weights in the second number format may be divided into a plurality of subsets, each containing k weights. Each subset is packed into a set of p N-bit strings. p may be determined based on the ratio of b_{w} to the difference between N and b_{w}, with k based on the value of p or the ratio of N to b_{w} as described herein with respect to FIGS. 4A-C.

Turning to FIG. 1B, at operation 152 a bitstream is parsed by a decoder (e.g., a video decoder and/or an audio decoder) to obtain one or more sets of p N-bit numbers, an N-bit number indicates k weights of a neural network. The N-bit numbers each have a length, N, of a first number format, e.g., a single precision floating point number (32 bits) or a double precision floating point number (64 bits). The weights are represented in a second number format that represents numbers as a sequence of bits of length, b_{w}, that is less than the length of the first number format, i.e., b_{w}<N.

In some embodiments, the neural network may comprise a plurality of modules, with each module associated with a respective second number format. In some examples, the respective second number formats of the modules are identical, i.e. all modules use the same second number format to encode their respective weights. In some examples, the respective number format of one or more of the modules may be a different second number format to at least one of the other modules, i.e., there are a plurality of second number formats used to encode weights of the neural network.

The set of weights may be arranged sequentially in the one or more sets N-bit numbers in the same order as the indexing of the weights in the neural network.

At operation 154, a bitstream is parsed by the decoder to obtain an indication of a respective mantissa length and/or respective exponent length of the one or more second number formats. For example, the number of bits representing the mantissa and/or the number of bits representing the exponent are received in the bitstream/as side information. In some examples, a plurality of mantissa lengths and/or exponent lengths are received, each corresponding to a respective one or more modules of the neural network. In other examples, a single mantissa length and/or exponent length is received and used for all modules of the neural network.

At operation 156, the weights of the neural network are extracted from the one or more sets of p N-bit numbers based on the respective mantissa length and/or respective exponent length of the one or more second number formats.

In some embodiments, at operation 158, a neural network with the extracted weights is executed on one or more sets of input data to generate one or more sets of output data.

In some embodiments, the neural network performs an image processing task. The image processing task may, for example, comprises one or more of: an image enhancement task (e.g. take an image as input and output a denoised and/or super resolved version of the image); an image generation task (e.g. take noise and, in some examples, conditioning data as input and generate an output image); an image classification task (e.g. take an image as input and output a distribution over a plurality of image classes); an image segmentation task (e.g. take an image as input and output a segmented image); an image captioning task (e.g. take an image as input and output a natural language description of the image); and/or an object detection task (e.g. take an image as input and output a location/bounding box for each of one or more objects in the image).

In some embodiments, the neural network performs an audio processing task. The audio processing task may, for example, comprises one or more of: an audio enhancement task (e.g. take an audio sample as input and output a denoised version of the image); an audio generation task (e.g. take noise and, in some examples, conditioning data as input and generate an output audio sample); an audio classification task (e.g. take an audio sample as input and output a distribution over a plurality of audio classes); a hotword detection task (e.g. take an audio sample as input and output a probability that the audio contains a hotword); and/or a text-to-speech task (e.g. take an audio sample containing speech as input and output a text of the speech).

FIG. 2A shows a flow diagram of a method 200A for determining a minimum number of significant digits for representing mantissas of weights of a neural network. The method may be performed for a neural network as a whole, or for one or more modules of a neural network individually.

At operation 202, an initial candidate number of significant digits, nₘ, for the mantissa is set. In the example shown the initial number of significant digits is 1, though in other examples it may be higher than 1, e.g., 2 or 3, so long as the number of digits is less than the maximum number of digits of a mantissa representable by the first number format.

At operation 204, the mantissas of weights of the neural network are reduced to the current candidate number of significant digits, i.e., a set of approximate mantissas is generated. The mantissa of each weight in the first number format may be transformed to the form a.bbbbb . . . prior to the reduction, where a is an integer value between 1 and 9, and b is an integer value between 0 and 9.

At operation 206, the weights of the neural network are updated to have the approximate mantissa values, i.e., an approximation of the neural network is generated with weights that have a lower number of significant figures for the mantissa than the true neural network.

At operation 208, a test dataset is used to evaluate the performance of the approximate neural network. The performance may be measured using one or more metrics. For each metric, values of the metric may be averaged over the test dataset to determine an average performance of the approximate neural network according to that metric, M.

At operation 210, each of the one or more average metric values is compared to one or more threshold values, e.g., a minimum threshold value, Mₘᵢₙ, and/or a maximum threshold value, Mₘₐₓ. The Mₘᵢₙ and/or Mₘₐₓ values for each considered metric may be taken based on the metric values obtained during the testing of the trained neural network.

If the one or more average metric values are each above a respective minimum value and/or below a respective maximum value, then the performance of the approximate neural network is considered acceptable, and the minimum number of significant digits of the mantissa 212 is set to the current candidate number of significant digits.

If one or more of the average metric values do not satisfy respective minimum threshold values and/or maximum threshold values, then the approximate neural network performance is not considered acceptable. In response, the number of significant digits is increased 214, e.g., increased by one. The method then returns to operation 204 for the next iteration.

If the candidate number of significant digits for the mantissa reaches the maximum number of digits for the first number format, then the method terminates, and the number of digits for the mantissa is not reduced from the true value, i.e., remains the same as in the first number format.

Following determination of the minimum number of significant digits of the mantissa 212, the minimum number of significant digits of the mantissa, bₘ, may be determined. Assuming a mantissa in the form of “a.bbbbb . . . “, after reducing the number of significant digits and omitting the decimal point the mantissa will be represented as “abbb” using natural binary code. The bit demand, bₘ, for the required number of significant digits nₘ in the mantissa is given by:

$${b}_{m} = 3 \times {n}_{m} + 1 for n \leq 3$$

$${b}_{m} = 3 \times {n}_{m} + 2 for 4 \leq n \leq 6$$

$${b}_{m} = 3 \times {n}_{m} + 3 for 7 \leq n \leq 9$$

and so on.

FIG. 2B shows a flow diagram of a method 250 for determining a minimum number of significant bits for representing exponents of weights of a neural network. The method may be performed for a neural network as a whole, or for one or more modules of a neural network individually.

At operation 252, an initial candidate number of significant bits, nₑ, for the exponent is set. In the example shown the initial number of significant bits is 3, though in other examples two or higher, e.g., 3, 4 or 5, so long as the initial number of bits is less than the maximum number of bits of an exponent representable by the first number format.

At operation 254, the bits of the exponents of the neural network are reduced to the current candidate number of significant bits, i.e., a set of approximate exponents is generated. In embodiments where the method 250 is performed after the method 200 of FIG. 2A, then the mantissas of the weights are also reduced to the number of significant digits 212 determined by method 200.

At operation 256, the weights of the neural network are updated to have the approximate exponent values, i.e., an approximation of the neural network is generated with weights that have a lower number of significant bits for the exponents (and mantissas, is also reduced) than the reference neural network.

At operation 258, a test dataset is used to evaluate the performance of the approximate neural network. The performance may be measured using one or more metrics. For each metric, values of the metric may be averaged over the test dataset to determine an average performance of the approximate neural network according to that metric, M.

At operation 260, each of the one or more average metric values is compared to one or more threshold values, e.g., a minimum threshold value, Mₘᵢₙ, and/or a maximum threshold value, Mₘₐₓ. The Mₘᵢₙ and/or Mₘₐₓ values for each considered metric may be taken based on the metric values obtained during the testing of the trained neural network.

If the one or more average metric values are each above a respective minimum value and/or below a respective maximum value, then the performance of the approximate neural network is considered acceptable, and the minimum number of significant bits of the exponent 262 is set to the current candidate number of significant bits.

If one or more of the average metric values do not satisfy respective minimum threshold values and/or maximum threshold values, then the approximate neural network performance is not considered acceptable. In response, the number of significant bits is increased 214, e.g., increased by one. The method then returns to operation 254 for the next iteration.

If the candidate number of significant bits for the exponents reaches the maximum number of bits for exponents in the first number format, then the method terminates, and the number of bits for the exponent is not reduced from the true value, i.e., remains the same as in the first number format.

In some embodiments, the method 200 of FIG. 2A is performed prior to the method 250 of FIG. 2B. In some alternative embodiments, the method 250 of FIG. 2B is performed prior to the method of FIG. 2A. In other embodiments, the methods of FIG. 2A and FIG. 2B may be combined into a single loop. In some embodiments, only one of FIG. 2A or FIG. 2B is performed, i.e., the number of significant digits of the mantissa or the number of significant bits of the exponent is fixed.

Following determination of the minimum number of significant digits of the mantissa 212 and/or the minimum number significant bits for the exponent, the weights in the second number format may be packed/encoded into one or more sets of numbers of the same length as the first number format, i.e. N-bit strings. FIG. 3 shows a flowchart of an example method 300 for packing weights in the second number format into numbers in the first number format.

At operation 302, a bit requirement, b_{w}, for a single weight in the second number format is determined. Assuming a single bit is used to indicate the sign of a weight, then the total bit requirement, b_{w}, for a single weight is:

$${b}_{w} = 1 + {n}_{e} + {b}_{m}$$

Where bₘ is the number of bits used to represent the mantissa. The second number format is, in some examples, a single sign bit, followed by two or more bits representing an exponent (one of which represents the exponent sign), followed by one or more bits representing a mantissa. The order of these three parts of the second number format may, in some examples, be changed, e.g., the bits representing the mantissa may occur prior to the bits representing the exponent. In examples where the weights are all positive, the sign bit may be omitted in the second number format.

The weights in the second format may be stored/encoded using strings of the same length as the first number format (i.e., N), such that batches of k strings are each stored in p N-bit numbers, as shown in FIGS. 4A-C. The choice of k and p may be determined so that k<p, so long as b_{w}<N.

At operation 304, the number, p, of N-bit numbers that will be used to encode each batch of strings is determined based on the values of N (i.e., the bit length of numbers in the first number format) and b_{w} (the bit length of numbers in the second number format). The value of p may be determined based on the value of N and the value of b_{w}. For example, in some implementations, p is given by the ceiling of b_{w} divided by the difference between N and b_{w} (i.e., the bit saving in the second number format):

$$p = ⌈ \frac{{b}_{w}}{N - {b}_{w}} ⌉$$

At operation 306, the size, k, of each batch of weights is determined based on p, b_{w} and/or N. The number of network weights stored in the p N-bit numbers (i.e., the batch size) can, in some embodiments, be calculated based on the formula:

$$k = p + 1 for \frac{N}{{b}_{w}} \leq 2$$

$$k = a \frac{N}{{b}_{w}} a for \frac{N}{{b}_{w}} > 2$$

where axa indicates the floor of x.

For some values of p and k, there will be a number of unused bits at the end of the final N-bit number in the batch of p N-bit numbers. The number of unused bits, bₙᵤ, is given by:

$${b}_{n u} = N - k \cdot {b}_{w} for \frac{N}{{b}_{w}} > 2 {b}_{n u} = p \times ( N - {b}_{w} ) - {b}_{w} for \frac{N}{{b}_{w}} \leq 2$$

$${b}_{n u} = N - k \times {b}_{w} for \frac{N}{{b}_{w}} > 2$$

Once the values of k and p have been determined, the weights of the neural network are divided into a plurality of batches at operation 308, each batch containing k weights. The weights may be ordered in the order they are indexed in the neural network, and consecutive weights assigned to each batch, e.g., for k=2, weights 1 and 2 in the weight indexing are assigned to the first batch, weights 3 and 4 are assigned to the second batch and so on.

At operation 310, each batch of k weights in the second number format is packed/arranged into a respective p N-bit strings, for example as shown in FIGS. 4A-C. The order of weights in a batch within the respective p N-bit strings corresponds to the indexing of the neural network weights. In the case where, after dividing all network weights into batches, the last batch contains fewer than k weights, the missing weights may be supplemented with a special ‘missing weight’ symbol.

Assuming that the last weight batch is fully packed, the data space reduction for weights is: τ=k/p. The application of the proposed method reduces the number of floating-point numbers in which neural network weights are stored. This leads to a reduction in the volume of files used to store network weights in the form of floating-point numbers, as instead of saving k floating-point numbers representing each batch of weights to a file, p floating-point numbers whose bits have been used to represent the k weights are saved. Reusing the weights, after reading from the file, may involve conversion back to the IEEE 754 format.

FIG. 4A shows an example of packing k weights into p N-bit numbers. In the example shown, a first weight in the second number format, w₁, occupies a first portion of a first N-bit number. The first weight comprises a sign bit, s₁, a plurality of bits, exp₁, representing an exponent of the first weight and a plurality of bits, mant₁, representing the mantissa of the first weight. A first part of a second weight in the second number format, w₂, occupies a second portion of the first N-bit number. The first part of the second weight has, in this example, a sign of the second weight, s₂, and a first part of the exponent, exp₂, of the second weight.

The remaining part of the second weight, w₂, occupies a first part of a second N-bit number. The remaining part of the second weight has, in this example, the remaining parts of the exponent of the second weight, exp₂, and the mantissa of the second weight, mant₂. The second weight is followed by a third weight, w₃, that spans the boundary between the second N-bit number and a third N-bit number (not shown), and so on until the k-th weight in the batch, wₖ, is reached. The k-th weight, in this example, spans the p-th N-bit number is reached. In the example shown, the k-th weight spans the boundary between the (p-1)-th N-bit number and the p-th N-bit number. A final sequence of bits of the p-th N-bit number is not used; these may be packed with an “unused bit” symbol, e.g., one or more zeros or ones.

FIG. 4B shows an example of packing three weights into two floating point numbers. In the example shown, the floating-point numbers (i.e., the first number format) are single precision floating point numbers, i.e., are 32 bits long (N=32), with the second number format having a minimum number of significant digits for the mantissa as nₘ=4 and a minimum number of significant bits for the exponent as nₑ=6. Based on the methods described in FIG. 3, this gives bₘ=14, b_{w}=21, p=2, k=3, bₙᵤ=1 and τ=1.5.

A first weight, w₁, of the batch in the second number format, w₁, occupies the first 21 bits of the first 32-bit number, n₁. The first weight comprises a single sign bit, s₁, an exponent, exp₁, of 6 bits long and a mantissa, mant₁, of 14 bits long. The remaining 11 bits of the first 32-bit number are occupied by the first 11 bits of the second weight in the batch, w₂, i.e., the sign bit, s₂, the 6 bits of the exponent, exp₂, and the first 4 bits of the mantissa, mant₂.

The remaining 10 bits of the second weight, i.e., the second part of the mantissa, occupy the first ten bits of the second 32-bit number, n₂. The third weight, w₃, in the batch occupies the next 21 bits of the second 32-bit number. The third weight comprises a single sign bit, s₃, an exponent, exp₃, of 6 bits long and a mantissa, mant₃, of 14 bits long. The final bit of the second 32-bit number is not used, nu.

FIG. 4C shows an example of packing 2 weights into 1 floating point number. In the example shown, the floating-point numbers (i.e., the first number format) are single precision floating point numbers, i.e., are 32 bits long (N=32), with the second number format having a minimum number of significant digits for the mantissa as nₘ=3 and the minimum number of significant bits of the exponent as nₑ=5. Based on the methods described in FIG. 3, this gives bₘ=10, b_{w}=16, p=1,k=2, bₙᵤ=0 and τ=2.

A first weight, w₁, of the batch in the second number format, w₁, occupies the first 16 bits of the 32-bit number, n₁. The first weight comprises a single sign bit, s₁, an exponent, exp₁, of 5 bits long and a mantissa, mant₁, of 10 bits long. The remaining 16 bits of the first 32-bit number are occupied by the 16 bits of the second weight in the batch, w₂, i.e., the sign bit, s₂, the 5 bits of the exponent, exp₂, and the 10 bits of the mantissa, mant₂. No bits are unused.

FIG. 5 shows a schematic illustration of an encoder/compressor 40 according to an embodiment. Specifically, FIG. 5 shows a schematic illustration of an encoder/compressor 50 configured to perform any of the encoder methods discussed herein, e.g., the methods of FIG. 1A, 2A, 2B and/or 3. Such detailed descriptions thereof are omitted here for brevity. In some examples, the encoder is a video encoder. In some examples, the encoder is an audio encoder.

As shown in FIG. 5, the encoder 50 comprises a processor 51 and a computer readable medium 52. The processor 51 and the computer readable medium 52 may be connected via a bus system. The computer readable medium is configured to store programs, instructions or codes. The processor 51 is configured to execute the programs, the instructions or the codes in the computer readable medium 52 so as to complete the operations in the encoder method embodiments herein.

Hence, in embodiments, the computer readable medium 52 is configured to store a computer program capable of being run in the processor 51, and the processor 51 is configured to run the computer program to perform steps in any of the encoder methods discussed herein.

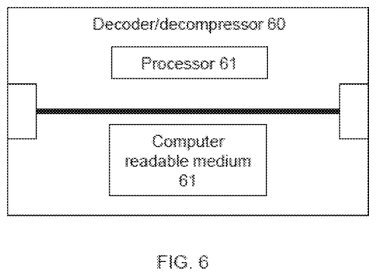

FIG. 6 shows a schematic illustration of a decoder/decompressor 60 according to an embodiment. Specifically, FIG. 6 shows a schematic illustration of a decoder/decompressor 60 configured to perform any of the decoder/decompression methods discussed herein, e.g., the method of FIG. 1B. Such detailed descriptions thereof are omitted here for brevity. In some examples, the decoder is a video decoder. In some examples, the decoder is an audio decoder.

As shown in FIG. 6, the decoder 60 comprises a processor 61 and a computer readable medium 62. The processor 61 and the computer readable medium 62 may be connected via a bus system. The computer readable medium is configured to store programs, instructions or codes. The processor 61 is configured to execute the programs, the instructions or the codes in the computer readable medium 62 so as to complete the operations in the decoder method embodiments herein.

Hence, in embodiments, the computer readable medium 62 is configured to store a computer program capable of being run in the processor 61, and the processor 61 is configured to run the computer program to perform steps in any of the decoder methods discussed herein.

Embodiments of the invention can also provide a computer-readable medium having computer-executable instructions to cause one or more processors of a computing device to carry out the method of any of the embodiments of the invention.

Examples of computer-readable media include both volatile and non-volatile media, removable and non-removable media, and include, but are not limited to: solid state memories; removable disks; hard disk drives; magnetic media; and optical disks. In general, the computer-readable media include any type of medium suitable for storing, encoding, or carrying a series of instructions executable by one or more computers to perform any one or more of the processes and features described herein.

It will be appreciated that the functionality of each of the components discussed can be combined in a number of ways other than those discussed in the foregoing description. For example, in some embodiments, the functionality of more than one of the discussed devices can be incorporated into a single device. In other embodiments, the functionality of at least one of the devices discussed can be split into a plurality of separate (or distributed) devices.

Conditional language such as “may”, is generally used to indicate that features/steps are used in a particular embodiment, but that alternative embodiments may include alternative features, or omit such features altogether.

Furthermore, the method steps are not limited to the particular sequences described, and it will be appreciated that these can be combined in any other appropriate sequences. In some embodiments, this may result in some method steps being performed in parallel. In addition, in some embodiments, particular method steps may also be omitted altogether.

While certain embodiments have been discussed, it will be appreciated that these are used to exemplify the overall teaching of the present invention, and that various modifications can be made without departing from the scope of the invention. The scope of the invention is to be construed in accordance with the appended claims and any equivalents thereof.

Many further variations and modifications will suggest themselves to those versed in the art upon making reference to the foregoing illustrative embodiments, which are given by way of example only, and which are not intended to limit the scope of the invention, that being determined by the appended claims.

1. A method of compressing a set of weights for a neural network, the method performed by a video encoder or audio encoder, the method comprising:
receiving, from a source, a plurality of weights of a neural network in a first number format, wherein a weight is represented in the first number format by N bits comprising a plurality of bits representing an exponent of the weight and a plurality of bits representing a mantissa of the weight and one bit representing a sign of the weight; and
converting the plurality of weights into a second number format, wherein a weight is represented in the second number format by b_{w} bits comprising a plurality of bits representing the exponent of the weight, a plurality of bits representing the mantissa of the weight and one bit representing the sign of the weight, wherein b_{w}<N, the converting comprising:
determining a minimum number of significant bits for representing the mantissas of the weights of the neural network and/or a minimum number of significant bits for representing the exponents of the weights of the neural network that maintains a threshold performance of the neural network; and
approximating the mantissa and/or exponent of a weight of the weights as a plurality of bits of length equal to the minimum number of significant bits for representing the mantissas and/or exponent respectively, and
encoding the plurality of weights of the second number format into a bitstream.

2. The method of claim 1, wherein determining the minimum number of significant bits for representing the mantissas of the weights of the neural network that maintains the threshold performance of the neural network comprises:
determining a minimum number of significant digits for representing the mantissas of the weights of the neural network; and
converting the minimum number of significant digits to the minimum number of significant bits.

3. The method of claim 2, wherein determining a minimum number of significant digits for representing the mantissas of the weights of the neural network comprises: iteratively increasing a number of significant bits for representing the mantissas of the weights from an initial value until the threshold performance of the neural network is reached.

4. The method of claim 3, wherein iteratively increasing the number of significant digits for representing the mantissas of the weights from the initial value until the threshold performance of the neural network is reached comprises, at each iteration:
determining a candidate number of significant digits of the mantissa for the iteration;
generating a candidate set of weights for the iteration by reducing the number of significant digits of the mantissas of the weights from the first number format to the candidate number of significant digits of the mantissa;
executing the neural network with the candidate set of weights on a set of test data;
comparing the performance of the neural network with the candidate set of weights to the threshold performance; and
if the threshold performance is reached, setting the minimum number of significant digits for representing the mantissas of the weights to the candidate number of significant bits of the mantissa for the iteration.

5. The method of claim 4, wherein comparing the performance of the neural network with the candidate set of weights to the threshold performance comprises:
determining values of one or more metrics on output data obtained from executing the neural network with the candidate set of weights on the set of test data;
comparing the determined values of the one or more metrics to one or more threshold values.

6. The method of claim 5, wherein:
the neural network is an image generation or image enhancement neural network;
the one or more metrics comprise one or more of: a mean square error; a peak signal to noise ratio; a structural similarity index measure; and/or a visual information fidelity.

7. The method of claim 1, wherein converting the plurality of weights into the second number format further comprises:
determining a minimum number of significant bits for representing the exponents of the weights of the neural network that maintains the threshold performance of the neural network; and
approximating the exponents of a weight of the weights as a plurality of bits with length equal to the minimum number of significant bits for representing the exponents.

8. The method of claim 7, wherein determining the minimum number of significant bits for representing the exponents of the weights of the neural network that maintains the threshold performance of the neural network comprises:
iteratively increasing a number of significant bits for representing the exponents of the weights from an initial value until the threshold performance of the neural network is reached.

9. The method of claim 8, wherein iteratively increasing the number of significant bits for representing the exponents of the weights from the initial value until the threshold performance of the neural network is reached comprises, at each iteration:
determining a candidate number of significant bits of the exponents for the iteration;
generating a candidate set of weights for the iteration by reducing the number of significant bits of the exponents of the weights from the first number format to the candidate number of significant bits of the exponents;
executing the neural network with the candidate set of weights on a set of test data;
comparing the performance of the neural network with the candidate set of weights to the threshold performance; and
if the threshold performance is reached, setting the minimum number of significant bits for representing the exponents of the weights to the candidate number of significant bits of the exponents for the iteration.

10. The method of claim 9, wherein comparing the performance of the neural network with the candidate set of weights to the threshold performance comprises:
determining values of one or more metrics on output data obtained from executing the neural network with the candidate set of weights on the set of test data;
comparing the determined values of the one or more metrics to one or more threshold values.

11. The method of claim 1, further comprising: packing the plurality of weights in the second number format into a plurality of N-bit strings to form a compressed representation of the plurality of weights.

12. The method of claim 11, wherein packing the plurality of weights in the second number format into a plurality of N-bit numbers comprises:
sequentially ordering the weights in the weights in the second number format such that the ordering of the weights corresponds to an indexing of the weights of the neural network.

13. The method of claim 11, wherein packing the plurality of weights in the second number format into a plurality of N-bit numbers comprises:
determining a number of N-bit numbers, p, for storing a batch of k weights, wherein p<k;
dividing the plurality of weights in the second format into a plurality of sets of k weights; and
packing each set of k weights into a respective set of p N-bit numbers.

14. The method of claim 1, wherein the first number format is a single precision floating point number format or a double precision floating point number format.

15. A method of decoding weights for a neural network, the method performed by a video decoder or an audio decoder, the method comprising:
parsing a bitstream to obtain one or more sets of p N-bit numbers, an N-bit number indicating a respective k weights of the neural network, wherein the N-bit numbers have a length of a first number format, and the weights are represented in one or more second number formats, wherein 1≤p<k;
parsing the bitstream to obtain an indication of a respective mantissa length and/or respective exponent length of the one or more second number formats;
extracting the weights of the neural network from the one or more sets of p N-bit numbers based on the respective mantissa length and/or respective exponent length of the one or more second number formats.

16. The method of claim 15, further comprising:
executing a neural network with the extracted weights on one or more sets of input data to generate one or more sets of output data.

17. The method of claim 16, wherein the neural network performs an image processing task, and the one or more sets of input data comprise an input image.

18. The method of claim 17, wherein the image processing task comprises one or more of: an image enhancement task; an image generation task; an image classification task; an image segmentation task; an image captioning task; and/or an object detection task.

19. The method of claim 15, wherein the order of the weights of the neural network in the one or more sets of p N-bit numbers corresponds to a predefined indexing of the neural network weights.

20. A decoder comprising:
one or more processors; and
a computer-readable medium comprising computer executable instructions stored thereon that, when executed by a computer, cause the computer to perform the method of claim 15.
